(19) United States
(12) Patent Application Publication
(10) Pub. No.: US 2003/0152671 A1
(43) Pub. Date: Aug. 14, 2003

(54) Method and apparatus for packing green particulate feed stock material

(76) Inventor: Peter James Johnstone, Reservoir (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/311,670

(22) PCT Filed: Jun. 18, 2001
(86) PCT No.: PCT/AU01/00720

(30) Foreign Application Priority Data
Jun. 19, 2000 (AU) PQ8206

(51) Int. Cl. B65B 13/02; C12C 1/027

(52) U.S. Cl. 426/106; 53/399; 53/434; 53/436; 53/449; 53/512; 53/585; 53/526; 53/176; 206/497

(57) ABSTRACT

The specification discloses a method and apparatus for producing a package containing high moisture content particulate plant material intended for human consumption or for use as animal feed stock which will preserve same without the particulate plant material undergoing a drying process, the method involving either providing a flexible walled container or alternatively forming such a container from a web of plastics material cling film (15), at least partially filling the flexible walled container with particulate plant material via a delivery chute (17) into an upper open mouth of the flexible walled container, pressing the particulate plant material to expel air therefrom, closing the flexible walled container and preferably applying two circumferentially extending bands (22, 23) of plastics material film overlapping one another at 90° around the closed flexible walled container with sufficient web thicknesses and tension to compress the flexible walls of said container inwardly.

The present invention relates to preserving and storage of high moisture content particulate plant material such as grains including barley, maize, chopped maize, legumes including soya beans, rice, chopped root vegetables including potatoes and sugar beet, and like materials. Such materials may be intended for either human consumption or for use as stock feeds.

Traditionally, high moisture content particulate plant materials of the aforementioned kind are preserved for later use by being dried prior to being packed in bags or the like for transport or storage. The drying process adds considerably to the expense of such materials and further has a deleterious effect on some nutrients in the material. It is also known to produce silage for use as animal feed by forming wilted cut grass into bales and forming an anaerobic envelope around such bales by wrapping same with plastics stretch and cling film such as linear low density polyethylene (LLDPE). Such techniques have not, however, been possible with high moisture content green particulate as such materials cannot be formed initially into a self supporting bale.

The objective therefore of the present invention is to provide a method, and apparatus for carrying out the method, for reliably storing and preserving high moisture content particulate feed stock material of the above identified without the need to dry same as a preliminary step. A further preferred objective is to provide a novel form of package capable of use in the aforementioned process.

Accordingly, the present invention provides a method of forming a package containing high moisture content particulate plant material, said method including delivering the high moisture content particulate plant material to a flexible walled container with an open mouth portion, compressing the particulate material within the container to expel air from the mass of said green particulate material, wrapping at least one band of plastics material film circumferentially about said container overlying said open mouth portion to form an anaerobic zone within said container and said at least one band, said at least one band of plastics material having sufficient individual web thicknesses and tension to compress the sides of said flexible walled container inwardly. Conveniently, a second band of plastics material stretch and cling film is located circumferentially about said package also overlying said open mouth portion and arranged at 90° to said one band, said second band of plastics material also being wrapped with sufficient web thicknesses and tension to compress the sides of said flexible walled container inwardly.

Conveniently the aforesaid band, or multiple bands are formed by prestretched plastics film material retaining some memory whereby after application, the band or bands continue to provide an inward constricting force to both prevent the ingress of air into the container and to tend to expel air from the container.

The compression of the high moisture content particulate material in the container may occur while the container is at least partially open or after closure of same. In one preferred embodiment, compression of the particulate material may occur prior to closing the container and again after closure of the container. Compression of the material also limits the space within the package where insects and other pests may exist and grow, thereby avoiding or limiting the need to use insecticides and pesticides.

By providing compression of the particulate material either prior to and/or after closure of the container and also via the external pressure from at least one retaining band, and preferably two such bands as defined above, it is possible to expel most of the air from the package thus formed thus providing a secure storage container which also will preserve the contents without having to dry the material first. The container is preferably formed from plastics material film cold pre-stretched to beyond its yield point to increase its length and reduce its thickness.

Preferred aspects and features of the present invention may be as disclosed in claims 7 to 9 as annexed hereto which are hereby made part of this disclosure.

In accordance with another aspect of this invention there is provided a package for preserving and storing high moisture content particulate plant material, said package including a flexible walled container adapted to hold the particulate plant material, a first band of plastics material film circumferentially wrapped about said container with sufficient web thicknesses and tension to compress sides of said container inwardly, said first band also overlying a delivery opening to said container, said package further including a second band of plastics material circumferentially wrapped about said container also overlying said delivery opening and arranged at 90° to said first band, said second band of plastics material also being wrapped with sufficient web thicknesses and tension to compress the sides of said flexible walled container inwardly whereby the particulate plant material is immobilised within said container.

In accordance with a still further aspect, the present invention also provides a package for preserving and storing high moisture content particulate plant material, said package including a closed flexible walled container containing said particulate plant material in a compressed state, a first band of plastics material film circumferentially wrapped about said container with sufficient web thicknesses and tension to compress sides of said container inwardly, and a second band of plastics material film circumferentially wrapped about said container intersecting said first band at 90°, said second band also being wrapped with sufficient web thicknesses and tension to compress the sides of said flexible walled container inwardly whereby the particulate plant material is immobilised within said container.

Preferred features relating to this aspect of the present invention may be as disclosed in claims 12 to 16 as annexed hereto which are hereby made part of this disclosure.

According to yet another aspect of this invention, apparatus is provided for forming a package containing high moisture content particulate plant material, said apparatus including delivery means for delivering said particulate plant material to a flexible walled container with an open mouth portion; compression means for compressing said particulate plant material within said flexible walled container to expel air therefrom; closure means to close said open mouth portion of the container to form an anaerobic zone within said container; and means to apply at least one band of plastics material film circumferentially around said flexible walled container having sufficient individual web thicknesses and tension to compress sides of said flexible walled container inwardly.

Further preferred features relating to this aspect of the present invention may be as disclosed in claims 18 to 21 as annexed hereto which are hereby made part of this disclosure.

Preferred embodiments and features of this invention may be as disclosed hereinafter with reference to the accompanying drawings, in which :—

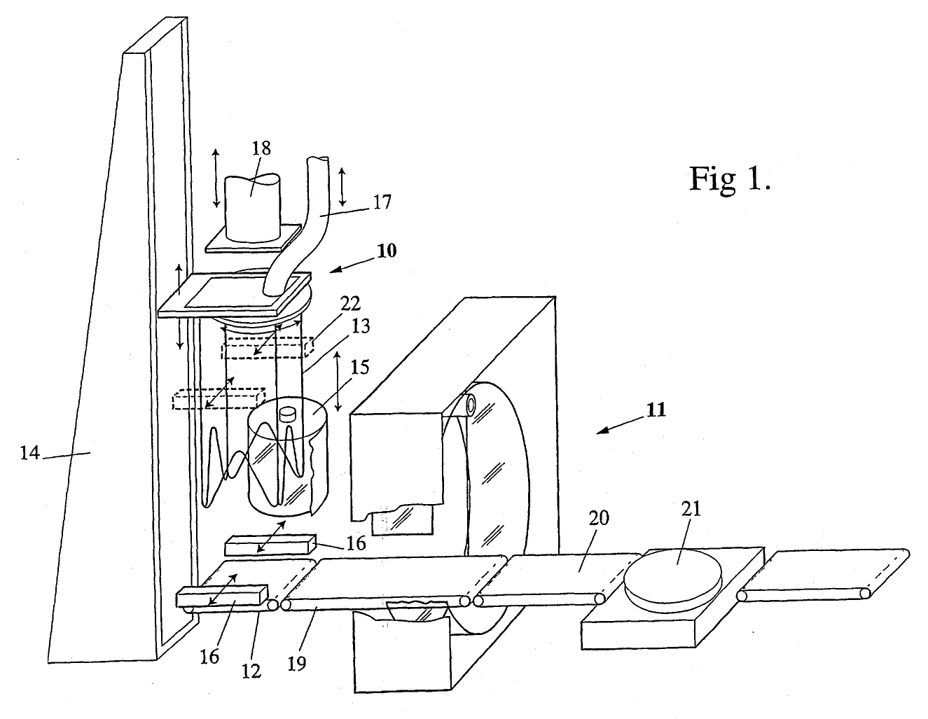

FIG. 1 illustrates schematically one form of apparatus that may be used in the process of the present invention; and

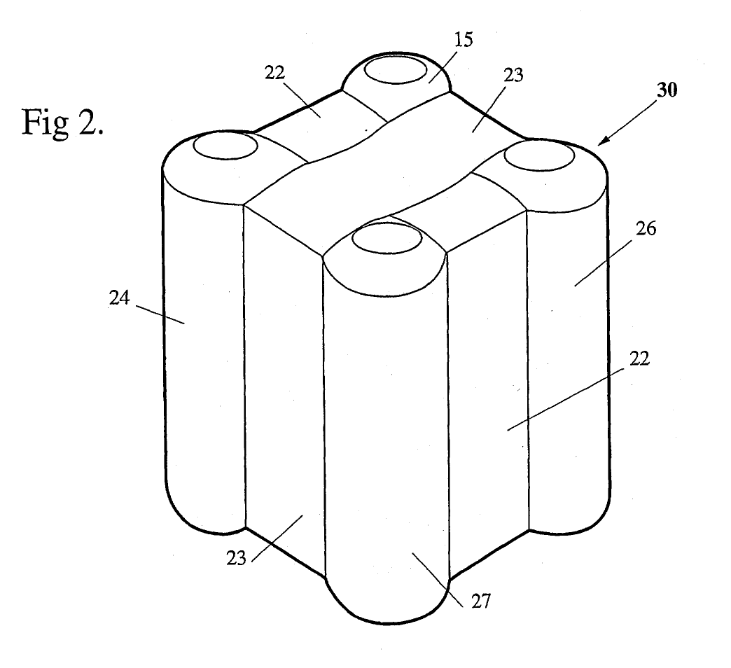

FIG. 2 illustrates schematically a form of package that may result from carrying out the process of the present invention.

Referring first to FIG. 1, the apparatus comprises a package forming station 10 and a package banding station 11 adjacent one another. The package forming station includes a lower support conveyor 12 on which the package may be formed. The station 10 further includes an open frame 13 which is capable of being raised or lowered on the support column 14 and rotated about its longitudinal (upright) axis. Plastics material film from a roll 15 may be wrapped initially around lower regions of the frame under tension such that lower edges of the film tend to constrict inwardly and can be closed off beneath the frame 13 either by tying same or by heat sealing jaws 16 or by any other suitable means to form a sufficiently closed base region of the package to contain the material being packed. The film roll 15 may be caused to rise while continuing to wrap film around the frame 13 to form lower side walls of the package being formed. The package filling process may then commence via a fill tube 17 to deliver green particulate feed stock material or similar materials for human consumption such as grains, chopped maize, legumes and the like into the at least partially formed package. Reference may be made in the following to stock feed materials but it should be understood that similar materials for human consumption may also be preserved. When the desired volume or perhaps weight of feed material has been delivered into the partially formed package, the filling tube 17 may be removed and a press platen 18 may be lowered into the partly formed package to compact the feed material therein to reduce as far as possible the air volume in he material packed within the package. If a large or deep package is being formed, this pressing step may be repeated at stages during the package production. In the case of a large or deep package, the open frame 13 may be caused to move upwardly as film from the roll 15 is wound around the frame 13, the roll 15 also moving upwardly at the same time. The frame 13 is therefore progressively withdrawn from the filling material. When the desired size of package is reached, the film winding process may continue as the frame 13 is upwardly withdrawn from the filling material. As a result of the film winding tension, the film between the lower end of the frame 13 and the upper surface of the filling material constricts inwardly and can be closed off by tying, by heat sealing jaws 22, or by any other method as close as possible to the top surface of the filling material to limit the amount of air captured within the package. At this point, the lower end or base section of the next package may be simultaneously or separately formed and the process can be repeated by lowering the frame 13 back to the lower support conveyor 12.

If desired, particularly for a container formed from wound webs of plastics material cling film, once the container has been fully closed, it may be further externally pressed to both shape the container and additionally expel air through the zones between overlapping layers of the plastics material cling film.

In potential alternative arrangements the initial container may be a preformed bag which could simplify the process when making smaller packages. The frame 13 in another embodiment might move upwardly to disengage same from the material being packed rather than to make bigger packages as discussed above.

The package thus formed and at least temporarily closed is then quickly moved via the conveyors 12 and 19 to the banding station 11. At the station 11, a band of plastic stretch film is dispensed from an orbiting stretch film dispenser apparatus and is wrapped around the package under tension a number of times to form a single band thereby creating an anaerobic envelope surrounding the material within the package.

The single band is wrapped under sufficient tension to compress the side walls of the package inwardly which has the effect of expelling further air from within the package and, at the same time sealing (if this has not occurred previously) the top and bottom opening regions of the package. The package thus partially formed is moved via a further conveyor 20 onto a turntable 21 and is rotated through 90° before being returned via conveyor 20 to the banding station 11. At the banding station 11, a second band is formed by wrapping the package with a further film web under sufficient tension to compress the side walls of the package inwardly to a degree similar to the first band with the resultant package appearing as shown in FIG. 2 of the annexed drawings. In this drawing the package has side walls and top and bottom walls formed from plastics material film from the roll 15 and a first band 22 and a second band 23. Because of the tightness of winding of the bands 22, 23, the particulate material within the package is held such that it cannot move within the package and the oxygen content of the package is very small and is quickly used up without being able to be replenished. Moreover, four pillars 24, 25, 26, and 27 are formed at the corners of the package that provide rest supports to allow similar shaped packages to be stored next to one another and on top of one another.

The claims defining the invention are as follows:

1. A method of forming a package containing high moisture content particulate plant material, said method including delivering the high moisture content particulate plant material to a flexible walled container with an open mouth portion, compressing the particulate material within the container to expel air from the mass of said particulate material, wrapping at least one band of plastics material film circumferentially about said container overlying said open mouth portion to form an anaerobic zone within said container and said at least one band, said at least one band of plastics material having sufficient individual web thicknesses and tension to compress the sides of said flexible walled container inwardly.

2. A method according to claim 1, wherein a second band of plastics material film is located circumferentially about said package also overlying said open mouth portion and arranged at 90° to said one band, said second band of plastics material also being wrapped with sufficient web thicknesses and tension to compress the sides of said flexible walled container inwardly.

3. A method according to claim 1 or claim 2, wherein the said one band is formed from prestretched plastics film material retaining some memory whereby said one band provides an inward constricting force to said container after application to said container.

4. A method according to claim 2, wherein said second band of plastics material is formed from prestretched plastics material retaining some memory whereby said second band provides an inward constricting force to said container after application to said container.

5. A method according to any one of claims 1 to 4, wherein said particulate material is compressed within said container before fully closing said container.

6. A method according to any one of claims 1 to 5, wherein said particulate material is compressed within said container after fully closing said container.

7. A method according to claim 1 or claim 2, wherein said flexible walled container is a preformed bag produced from plastics film material.

8. A method according to claim 1 or claim 2, wherein the flexible walled container is formed from a plastics material film web wrapped around an open frame, the frame being removed after at least partial filling by the particulate material.

9. A method according to anyone of claims 1 to 8, wherein the open mouth of the container is at least temporarily closed prior to application of said at least one band.

10. A package for preserving and storing high moisture content particulate plant material, said package including a flexible walled container adapted to hold the particulate plant material, a first band of plastics material film circumferentially wrapped about said container with sufficient web thicknesses and tension to compress sides of said container inwardly, said first band also overlying a delivery opening to said container, said package further including a second band of plastics material circumferentially wrapped about said container also overlying said delivery opening and arranged at 90° to said first band, said second band of plastics material also being wrapped with sufficient web thicknesses and tension to compress the sides of said flexible walled container inwardly whereby the particulate plant material is immobilised within said container.

11. A package for preserving and storing high moisture content particulate plant material, said package including a closed flexible walled container containing said particulate plant material in a compressed state, a first band of plastics material film circumferentially wrapped about said container with sufficient web thicknesses and tension to compress sides of said container inwardly, and a second band of plastics material film circumferentially wrapped about said container intersecting said first band at 90°, said second band also being wrapped with sufficient web thicknesses and tension to compress the sides of said flexible walled container inwardly whereby the particulate plant material is immobilised within said container.

12. A package according to claim 11, wherein the second band overlies said first band at intersecting points of said bands.

13. A package according to claim 11 or claim 12, wherein at least one of said bands overlies a delivery opening for said particulate plant material entering said container.

14. A package according to claim 13, wherein both said bands overly said delivery opening.

15. A package according to claim 13 or claim 14, wherein at least one of said bands closes and seals said delivery opening.

16. A package according to any one of claims 11 to 15, wherein said first and second bands are formed from prestretched plastics material film retaining some memory whereby said bands provide an inward constricting force to said container after application to said container.

17. Apparatus for forming a package containing high moisture content particulate plant material, said apparatus including delivery means for delivering said particulate plant material to a flexible walled container with an open mouth portion; compression means for compressing said particulate plant material within said flexible walled container to expel air therefrom; closure means to close said open mouth portion of the container to form an anaerobic zone within said container; and means to apply at least one band of plastics material film circumferentially around said flexible walled container having sufficient individual web thicknesses and tension to compress sides of said flexible walled container inwardly.

18. Apparatus according to claim 17, wherein said apparatus includes means to form said flexible walled container from a continuous web of plastics material stretch and cling film, said means including a frame defining a storage volume and dispensing means to wrap said plastics material stretch and cling film about said frame in overlapping layers with the lower most film layers being sealed to form a closed lower end of the flexible walled container.

19. Apparatus according to claim 18, wherein said compression means contacts the particulate plant material directly within the flexible walled container via access through the open mouth.

20. Apparatus according to claim 18, wherein said compression means contacts the flexible walls of said flexible walled container after closure and sealing of said open mouth portion to compress the particulate plant material therein, air being expelled from said particulate plant material exits the package by passing at least partially between overlapping layers of said plastics material stretch and cling film.

21. Apparatus according to any one of claims 17 to 20, wherein said means to apply at least one band of plastics material film enables two said bands to be applied intersecting one another at 90°.
